(19) United States
(12) Patent Application Publication
(10) Pub. No.: US 2017/0350714 A1
(43) Pub. Date: Dec. 7, 2017

(54) ROUTE PLANNING BASED ON CONNECTIVITY OF NODES

(71) Applicant: INTERNATIONAL BUSINESS MACHINES CORPORATION, Armonk, NY (US)

(72) Inventors: Ning Duan, BeiJing (CN); Peng Gao, BeiJing (CN); Miao He, Chao Yang (CN); Bing Shao, BeiJing (CN)

(21) Appl. No.: 15/174,137

(22) Filed: Jun. 6, 2016

(51) Int. Cl. G01C 21/34

(52) U.S. Cl. CPC G01C 21/34

(57) ABSTRACT

According to embodiments of the present disclosure, a method, a device and a computer program product for route planning based on connectivity of nodes are provided. The method comprises determining a first plurality of nodes from an origin to a destination. The method further comprises dividing the first plurality of nodes into a plurality of collections based on travel time. In addition, the method comprises determining a route from the origin to the destination by selecting nodes from the plurality of collections.

### BACKGROUND

Significant efforts have been made to develop in-vehicle navigation systems which may allow a driver to efficiently plan and execute his or her travel routes. However, the proposed routes are usually accurate only under current road conditions, while the road conditions may dynamically change over time. To this end, in addition to providing for the preplanning of travel routes, efforts have also been made to develop systems which may account for dynamic road conditions and traffic, such as accidents or traffic jams.

Some navigation systems may allow the driver to periodically reschedule his or her travel routes based on real-time traffic. However, when the driver's route is blocked and he/she wants to reschedule the travel route, few alternative options may be left at that moment. Other navigation systems may allow the driver to plan his or her travel routes based on predictive traffic. However, the traffic prediction may easily be affected by a number of random factors and thus may be of low accuracy over a relatively long time.

### SUMMARY

In general, example embodiments of the present disclosure include a method, device and computer program product for route planning based on connectivity of nodes.

In an aspect, embodiments of the present disclosure provide a computer-implemented method. The method comprises determining a first plurality of nodes from an origin to a destination. The method further comprises dividing the first plurality of nodes into a plurality of collections based on travel time. In addition, the method comprises determining a route from the origin to the destination by selecting nodes from the plurality of collections.

In another aspect, embodiments of the present disclosure provide a device. The device comprises a node determining module configured to determine a first plurality of nodes from an origin to a destination. The device further comprises a node dividing module configured to divide the first plurality of nodes into a plurality of collections based on travel time. In addition, the device comprises a route determining module configured to determine a route from the origin to the destination by selecting nodes from the plurality of collections.

In yet another aspect, embodiments of the present disclosure provide a computer program product that is tangibly stored on a non-transient machine-readable medium. The instructions, when executed on a device, cause the device to determine a first plurality of nodes from an origin to a destination. The instructions, when executed on the device, cause the device to divide the first plurality of nodes into a plurality of collections based on travel time. In addition, the instructions, when executed on the device, cause the device to determine a route from the origin to the destination by selecting nodes from the plurality of collections.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a block diagram of an electronic device in which embodiments of the present disclosure can be implemented;

FIG. 2A shows an environment 200 in which embodiments of the present disclosure can be implemented;

FIG. 2B is a schematic diagram illustrating cascaded route planning in accordance with embodiments of the present disclosure;

FIG. 3 is a flowchart of a method 300 for route planning in accordance with embodiments of the present disclosure;

FIG. 4 is a flowchart of a method 400 for determining a first plurality of nodes in accordance with embodiments of the present disclosure;

FIG. 5 is a flowchart of a method 500 for generating a second plurality of nodes in accordance with embodiments of the present disclosure;

FIG. 6 is a flowchart of a method 600 for selecting the first plurality of nodes from among the second plurality of nodes in accordance with embodiments of the present disclosure;

FIG. 7 is a flowchart of a method 700 for dividing the first plurality of nodes into a plurality of collections in accordance with embodiments of the present disclosure;

FIG. 8 illustrates an example of a plurality of collections obtained from the first plurality of nodes in accordance with embodiments of the present disclosure; and

FIG. 9 is a flowchart of a method 900 for determining a route from the origin to the destination in accordance with embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones describe below.

As used herein, the term “includes” and its variants are to be read as opened terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

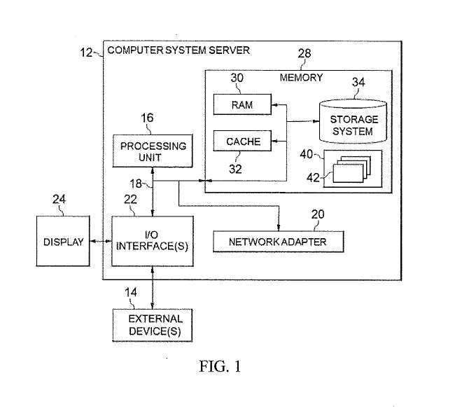

Reference is first made to FIG. 1, in which an exemplary electronic device or computer system/server 12 which is applicable to implement the embodiments of the present disclosure is shown. Computer system/server 12 is only illustrative and is not intended to suggest any limitation as to the scope of use or functionality of embodiments of the disclosure described herein. Computer system/server 12 may also be described herein as a processor system or a processor circuit.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, and the like. One or more devices that enable a user to interact with computer system/server 12; and/or any devices (e.g., network card, modem, etc.) that enable computer system/server 12 to communicate with one or more other computing devices. Such communication can occur via input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, and the like.

In computer system/server 12, I/O interfaces 22 may support one or more of various different input devices that can be used to provide input to computer system/server 12. For example, the input device(s) may include a user device such keyboard, keypad, touch pad, trackball, and the like. The input device(s) may implement one or more natural user interface techniques, such as speech recognition, touch and stylus recognition, recognition of gestures in contact with the input device(s) and adjacent to the input device(s), recognition of air gestures, head and eye tracking, voice and speech recognition, sensing user brain activity, and machine intelligence.

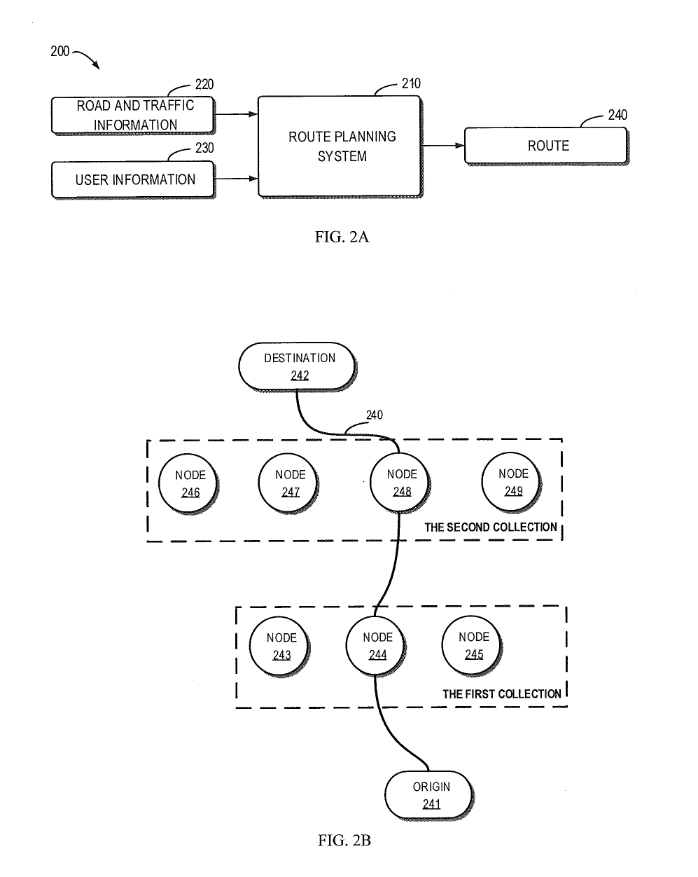

FIG. 2A shows an environment 200 in which embodiments of the present disclosure can be implemented. It is to be understood that the structure and functionality of the environment 200 are described only for the purpose of illustration without suggesting any limitations as to the scope of the present disclosure. The present disclosure can be embodied with a different structure and/or functionality.

As shown in FIG. 2A, the environment 200 may include a route planning system 210. The route planning system 210 may be implemented by computer system/server 12 as discussed with reference to FIG. 1, for example. The route planning system 210 may be configured to determine a route 240 from road and traffic information 220 and user information 230.

The road and traffic information 220 may include information associated with a road topology. Examples of such information include, but are not limited to, information about locations within the road topology, information about crosses within the road topology, information about roads connecting different locations and/or crosses, and the like. The road and traffic information 220 may also include information associated with traffic, such as historical information about the traffic and real-time information about the traffic.

The user information 230 may include an origin and a destination entered by a user, such as a driver. The user information 230 may also include the location of the user, such as the real-time location obtained from a positioning device of the user. For example, the positioning device can be used to determine the location of the user based on Global Positioning System (GPS) signals. Alternatively, or in addition, the user information 230 can be obtained based on any other technologies, either currently known or to be developed in the future. It is to be understood that the scope of the disclosure is not limited thereto.

The route 240 is composed of a series of nodes, through which the user can go from the origin to the destination. As used herein, the term “a node” refers to a specific location or an area with the road topology. The route planning system 210 may determine the route 240 base on the road and traffic information 220 and the user information 230.

FIG. 2B is a schematic diagram illustrating cascaded routing in accordance with embodiments of the present disclosure. As shown in FIG. 2B, the route 240 is composed of a series of nodes, through which the user can go from the origin 241 to the destination 242.

The route planning system 210 may firstly determine a plurality of nodes with relatively high connectivity from the road and traffic information 220. As used herein, the term “connectivity” associated with a node indicates the flexibility of the node with respect to other nodes within a road topology. For example, if a user has a number of options to continue travelling from a node, then the node is of relatively high connectivity. For example, starting from such a node, it is relatively easy for the user to turn left, turn right, turn around at the node, and/or travel to another node(s) within the road topology. The plurality of nodes may comprise nodes 243, 244, . . . , 249, for example.

Then, the route planning system 210 may cluster the plurality of nodes into a plurality of collections based on similarity of travel time estimated from the origin 241 to each of the plurality of nodes. For example, as shown in FIG. 2B, the route planning system 210 may cluster the plurality of nodes into two collections. The travel time from the origin 241 to each of the nodes in the second collection may be estimated to be approximately 2 times of that from the origin 241 to each of the nodes in the first collection. In this example, the first collection includes the nodes 243, 244 and 245, while the second collection includes the nodes 246, 247, 248 and 249.

The route planning system 210 may then determine the route 240 from the origin 241 to the destination 242 by incrementally selecting nodes from the two collections. For example, the route planning system 210 may firstly select a node associated with the highest connectivity from among the nodes in the first collection, such as the node 244, which has higher connectivity than the nodes 243 and 245. As such, a segment of the route 240 from the origin 241 to the node 244 can be determined. Likewise, the route planning system 210 may then select a node associated with the highest connectivity from among the nodes in the second collection, such as the node 248, which has higher connectivity than the nodes 246, 247 and 249. As such, a segment of the route 240 from the node 244 to the node 248 can be determined. Finally, the entire route 240 from the origin 241 to the destination 242 via the nodes 244 and 248 is determined.

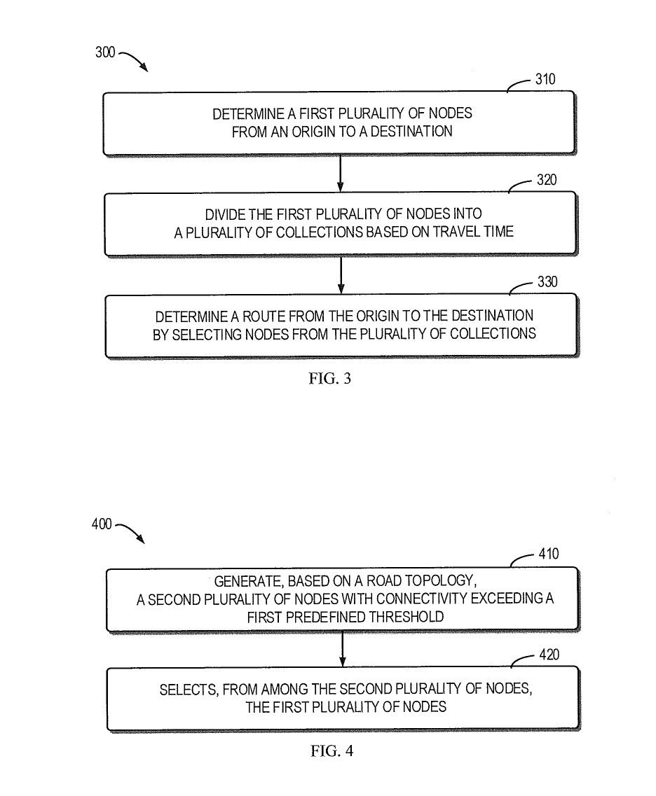

More details of embodiments of the present disclosure will now be discussed hereafter with reference to FIG. 3 to FIG. 9. FIG. 3 shows a flowchart of a method 300 for route planning in accordance with embodiments of the present disclosure. The method 300 will be described in connection with the environment 200 shown in FIG. 2A. For example, in some embodiments, the method 300 may be performed by the route planning system 210.

The method 300 is entered in operation 310, where the route planning system 210 determines a first plurality of nodes from an origin to a destination. FIG. 4 shows a flowchart of a method 400 for determining the first plurality of nodes in accordance with embodiments of the present disclosure. The method 400 will be described in connection with the environment 200 shown in FIG. 2A. For example, the method 400 may be performed by the route planning system 210.

In operation 410, the route planning system 210 generates a second plurality of nodes with connectivity exceeding a first predefined threshold. As described above, the term “connectivity” associated with a node indicates the flexibility of the node with respect to other nodes within the road topology. As will be further described below, the connectivity associated with a node can be represented by a travel time, where a relatively short travel time may represent relatively high connectivity. That is, a node with high connectively has a high degree of freedom. For the sake of discussions, the term “connectivity” may also be referred to as “degree of freedom (DOF)” in the following discussions.

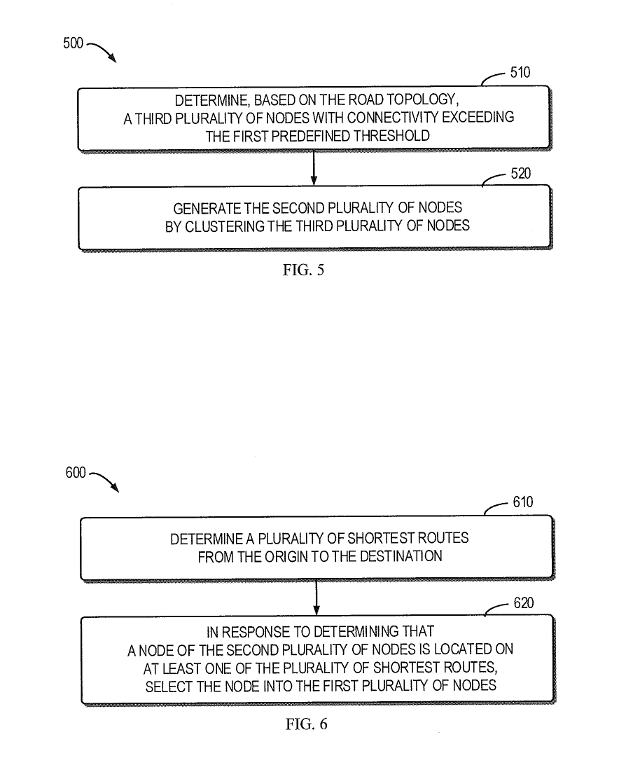

In some embodiments, the second plurality of nodes with connectivity exceeding the first predefined threshold can be generated based on a road topology. The road topology, as described above, can be part of the road and traffic information 220. For example, the information associated with the road topology may include information about nodes, crosses and roads connecting different nodes and/or crosses within the road topology. FIG. 5 shows a flowchart of a method 500 for generating the second plurality of nodes in accordance with embodiments of the present disclosure. The method 500 will be described in connection with the environment 200 shown in FIG. 2A. For example, the method 500 may be performed by the route planning system 210.

In operation 510, the route planning system 210 determines, based on the road topology, a third plurality of nodes with connectivity exceeding the first predefined threshold. In some embodiments, connectivity associated with a node can be determined based on at least one of the following factors: a distance from the node to a cross proximity to the node, a number of crosses in a predetermined distance from the node, and an average distance from the node to a plurality of nearest crosses to the node. As described above, connectivity associated with a node may indicate the flexibility of the node with respect to other nodes within the road topology.

In some embodiments, if the distance between a node and a cross is relatively short, the node may be considered to have high connectively. Likewise, if there are a larger number of crosses in the predetermined proximity of a node and/or the average distance from the node to the plurality of nearest crosses is short enough, the node can be determined as a high connectivity node.

If the node is denoted by “s”, the distance from the node to the cross proximity to the node can be denoted by “dₙₑₓₜ_{_}_{cross|s}”, the number of crosses in the predetermined distance from the node can be denoted by “n_{crosses|s}”, and the average distance from the node to the plurality of nearest crosses to the node can be denoted by “l_{average}_{_}_{distance|s}”. Then the connectivity of the node s (denoted by “DOFₛ”) can be determined as a function of dₙₑₓₜ_{_}_{cross|s}, n_{crosses|s} and l_{average}_{_}_{distance|s} as follows:

DOFₛ=f(dₙₑₓₜ_{_}_{cross|s},n_{crosses|s},l_{average}_{_}_{distance|s})

It is to be understood that the connectivity of the node can be determined based on other factors in addition to the above ones. The scope of the disclosure is not limited thereto. Next, in response to determining that the connectivity DOFₛ associated with the node s exceeds the first predefined threshold, the node s may be selected into the third plurality of nodes.

Then, the method 500 proceeds to operation 520, where the second plurality of nodes is generated by clustering the third plurality of nodes. A number of the third plurality of nodes may be large. In order to save computing power, the third plurality of nodes may be clustered to generate the second plurality of nodes. In some embodiments, main road intersections may be firstly identified from the road topology. As used herein, the term “main road intersection” refers to a cross across which the historical traffic exceeds a predefined threshold. Then, each of the third plurality of nodes can be clustered to its nearest main road intersection. In other embodiments, the clustering of the third plurality of nodes may be performed by dividing a grid representing the road topology. For example, the grid representing the road topology can be divided into a plurality of cells, each of which has a predefined width and length. Then, nodes from the third plurality of nodes located within one of the plurality of cells may be aggregated into one of the second plurality of nodes. As such, the second plurality of nodes is generated by clustering the third plurality of nodes.

Still in reference with FIG. 4, the method 400 proceeds to operation 420, where the route planning system 210 selects, from among the second plurality of nodes, the first plurality of nodes. In some embodiments, the first plurality of nodes can be selected by determining the shortest route from an origin to a destination. FIG. 6 shows a flowchart of a method 600 for selecting the first plurality of nodes from among the second plurality of nodes in accordance with embodiments of the present disclosure. The method 600 will be described in connection with the environment 200 shown in FIG. 2A. For example, the method 600 may be performed by the route planning system 210.

In operation 610, the route planning system 210 determines a plurality of shortest routes from the origin to the destination. As described above, the origin and the destination may be determined from the user information 230 and/or provided by the user. The route planning system 210 may determine the plurality of shortest routes from the origin to the destination based on, for example, k-shortest-paths (KSP) algorithm. Alternatively, or in addition, the plurality of shortest routes from the origin to the destination can be determined by any other algorithms, either currently known or to be developed in the future. The scope of the disclosure is not limited thereto. Then, the method 600 proceeds to operation 620, where a node of the second plurality of nodes is selected into the first plurality of nodes in response to determining that the node is located on at least one of the plurality of shortest routes.

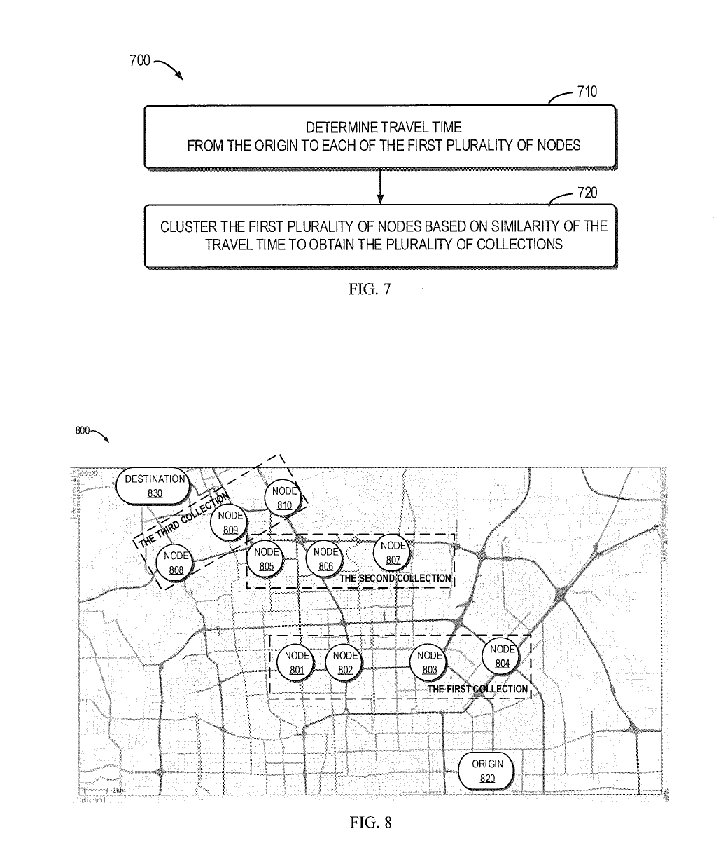

Referring back to FIG. 3, the method 300 proceeds to operation 320, where the route planning system 210 divides the first plurality of nodes into a plurality of collections based on travel time. In some embodiments, the first plurality of nodes may be divided into a plurality of collections based on travel time estimated from the origin to each of the first plurality of nodes. FIG. 7 shows a flowchart of a method 700 for dividing the first plurality of nodes into a plurality of collections in accordance with embodiments of the present disclosure. The method 700 will be described in connection with the environment 200 shown in FIG. 2A. For example, the method 700 may be performed by the route planning system 210.

In operation 710, the route planning system 210 determines travel time from the origin to each of the first plurality of nodes. In some embodiments, the travel time from the origin to each of the first plurality of nodes may be determined based on the road and traffic information 220. Specifically, the travel time may be estimated based on historical and real-time information about the traffic from the origin to each of the first plurality of nodes. Then, in operation 720, the first plurality of nodes is clustered based on similarity of the travel time to obtain the plurality of collections.

For example, for a given threshold of the travel time (denoted by t) and a given tolerance (denoted by σ) that is typically much less than t, the travel time associated with the first collection may lie within the range of [t−σ, t+σ], the travel time associated with the second collection may lie within the range of [2t−σ, 2t+σ], and the like. FIG. 8 illustrates an example of the plurality of collections obtained from the first plurality of nodes in accordance with embodiments of the present disclosure. As shown in FIG. 8, the first plurality of nodes may comprise nodes 801, 802 . . . 810, which are clustered into three collections, for example. The first collection may comprise the nodes 801, 802, 803 and 804. The second collection may comprise the nodes 805, 806 and 807. The third collection may comprise the nodes 808, 809 and 810.

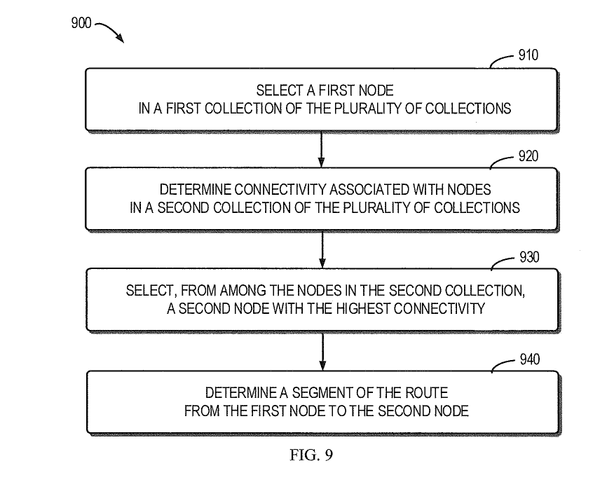

Still in reference with FIG. 3, the method 300 proceeds to operation 330, where the route planning system 210 determines a route from the origin to the destination by incrementally selecting nodes from the plurality of collections. FIG. 9 shows a flowchart of a method 900 for determining the route from the origin to the destination in accordance with embodiments of the present disclosure. The method 900 will be described in connection with the environment 200 shown in FIG. 2A and the example shown in FIG. 8. For example, the method 900 may be performed by the route planning system 210.

In operation 910, the route planning system 210 selects a first node in a first collection of the plurality of collections. In some embodiments, the first node may be selected based on the user information 230. Specifically, the first node may be selected based on the location of the user. That is, a node at which the user is currently located may be selected to be the first node. Only for the purpose of illustration, in the following discussions, the node 804 as shown in FIG. 8 is referred to as the first node.

In operation 920, the route planning system 210 determines connectivity associated with nodes in a second collection of the plurality of collections. For example, for the node 807 in the second collection as shown in FIG. 8, connectivity associated with the node 807 may be determined by weighting the following factors: a first parameter indicating connectivity from the node 807 to other nodes in the second collection, a second parameter indicating connectivity from the node 807 to nodes in the third collection, the determined travel time from the node 804 to the node 807, and the determined travel time from the node 807 to the destination 830.

The first parameter associated with the node s may be denoted by DOFᵢₙₜᵣₐ(s), which may be calculated as follows:

$${DOF}_{intra} ( s ) = {\sum }_{{s}^{′} \neq s , {s}^{′} is in the same collection with s} \frac{1}{{t}_{{ss}^{′}}} {DOF}_{{s}^{′}}$$

where s′ represents one of the other nodes in the same collection with s, tₛₛ, represents the determined travel time for the node s to the node s′ and DOF_{s′} represents the connectivity of the node s′. For example, t_{ss′} may be estimated based on historical and real-time information about the traffic. In addition, DOF_{s′} may be determined according to the formula (1) and may be normalized to travel time, as described above. The second parameter associated with the node s may be denoted by DOFₙₑₓₜ(s), which may be calculated as follows:

$${DOF}_{next} ( s ) = {\sum }_{{s}^{′} \neq s , {s}^{′} is in the next collection } \frac{1}{{t}_{{ss}^{′}}} {DOF}_{{s}^{′}}$$

where s′ represents a node in the next collection relative to s, t_{ss′} represents the determined travel time for the node s to the node s′ and DOF_{s′} represents the connectivity of the node s′. The determined travel time from the current node to the node s may be denoted by DOF_{reschedule} (s), which may be estimated based on historical and real-time information about the traffic. Further, the determined travel time from the node s to the destination may be denoted by DOF_{destination}(s). Then the connectivity associated with the node s may be determined as follows:

DOFₛ′=wᵢₙₜᵣₐDOFᵢₙₜᵣₐ(s)+wₙₑₓₜDOFₙₑₓₜ(s)+w_{reschedule}DOF_{reschedule}(s)+w_{destinationD}DOF_{destination}(s)

where each of wᵢₙₜᵣₐ, wₙₑₓₜ, w_{reschedule} and w_{destination} represents a weight for a respective factor. For example, the weights may be predetermined by the user or determined in any other ways.

Then, the method 900 proceeds to operation 930, where a second node with the highest connectivity is selected from among the nodes in the second collection. After determining connectivity associated with the nodes in the second collection according to the formula (4), a second node associated with the highest connectivity can be selected from among the nodes in the second collection. Only for the purpose of illustration, in the following discussions, the node 807 as shown in FIG. 8 is referred to as the second node.

Then, in operation 940, a segment of the route from the first node to the second node is determined. That is, the route from the node 804 to the node 807 may be determined as a segment of the route from the origin to the destination.

It is to be understood that the above example for determining the segment of the route from one of the nodes in the first collection to one of the nodes in the second collection is only for the purpose of illustration. It will be apparent to those skilled in the art that a segment of the route from the origin 820 to the one of the nodes in the first collection, a segment of the route from the one of the nodes in the second collection to one of the nodes in the third collection, and a segment of the route from the one of the nodes in the third collection to the destination 830 can be determined in similar ways as the above example. Only for the purpose of simplification, further detailed description is not provided herein. As such, the route from the origin to the destination can be determined by incrementally selecting nodes from the plurality of collections.

The present disclosure may be a system, an apparatus, a device, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining, using a processor system, a first plurality of nodes from an origin to a destination;
dividing, using the processor system, the first plurality of nodes into a plurality of collections based on travel time; and
determining, using the processor system, a route from the origin to the destination by selecting nodes from the plurality of collections.

2. The method of claim 1, wherein the determining the first plurality of nodes comprises:
generating, based on a road topology, a second plurality of nodes with connectivity exceeding a first predefined threshold; and
selecting, from among the second plurality of nodes, the first plurality of nodes.

3. The method of claim 1, wherein the generating the second plurality of nodes comprises:
determining, based on the road topology, a third plurality of nodes with connectivity exceeding the first predefined threshold; and
generating the second plurality of nodes by clustering the third plurality of nodes.

4. The method of claim 3, wherein the determining a third plurality of nodes based on the road topology comprises:
determining connectivity associated with a node based on at least one of the following factors:
a distance from the node to a cross proximity to the node;
a number of crosses in a predetermined distance from the node; and
an average distance from the node to a plurality of nearest crosses to the node; and
in response to determining that the connectivity associated with the node exceeds the first predefined threshold, selecting the node into the third plurality of nodes.

5. The method of claim 2, wherein the selecting the first plurality of nodes comprises:
determining a plurality of shortest routes from the origin to the destination; and
in response to determining that a node of the second plurality of nodes is located on at least one of the plurality of shortest routes, selecting the node into the first plurality of nodes.

6. The method of claim 1, wherein the dividing the first plurality of nodes into a plurality of collections comprises:
determining travel time from the origin to each of the first plurality of nodes; and
clustering the first plurality of nodes based on similarity of the travel time to obtain the plurality of collections.

7. The method of claim 6, wherein the determining travel time from the origin to each of the first plurality of nodes comprises:
determining the travel time based on historical and real-time information about the traffic from the origin to each of the first plurality of nodes.

8. The method of claim 1, wherein the determining a route from the origin to the destination by selecting nodes from the plurality of collections comprises:
selecting a first node in a first collection of the plurality of collections;
determining connectivity associated with nodes in a second collection of the plurality of collections;
selecting, from among the nodes in the second collection, a second node with the highest connectivity; and
determining a segment of the route from the first node to the second node.

9. The method of claim 8, wherein the determining connectivity associated with nodes in a second collection of the plurality of collections comprises:
determining connectivity associated with a third node in the second collection by weighting at least one of the following factors:
a first parameter indicating connectivity from the third node to other nodes in the second collection;
a second parameter indicating connectivity from the third node to nodes in a third collection of the plurality of collections;
the determined travel time from the first node to the third node; and
the determined travel time from the third node to the destination.

10. A device comprising:
a processing unit; and a tangible storage medium having instructions stored thereon for execution by the processing unit, the instructions, when executed by the processing unit, cause the device to perform actions including:
determining a first plurality of nodes from an origin to a destination;
dividing the first plurality of nodes into a plurality of collections based on travel time; and
determining a route from the origin to the destination by selecting nodes from the plurality of collections.

11. The device of claim 10, wherein the determining the first plurality of nodes comprises:
generating, based on a road topology, a second plurality of nodes with connectivity exceeding a first predefined threshold; and
selecting, from among the second plurality of nodes, the first plurality of nodes.

12. The device of claim 10, wherein the generating the second plurality of nodes comprises:
determining, based on the road topology, a third plurality of nodes with connectivity exceeding the first predefined threshold; and
generating the second plurality of nodes by clustering the third plurality of nodes.

13. The device of claim 12, wherein the determining a third plurality of nodes based on the road topology comprises:
determining connectivity associated with a node based on at least one of the following factors:
a distance from the node to a cross proximity to the node;
a number of crosses in a predetermined distance from the node; and
an average distance from the node to a plurality of nearest crosses to the node; and
in response to determining that the connectivity associated with the node exceeds the first predefined threshold, selecting the node into the third plurality of nodes.

14. The device of claim 11, wherein the selecting the first plurality of nodes comprises:
determining a plurality of shortest routes from the origin to the destination; and
in response to determining that a node of the second plurality of nodes is located on at least one of the plurality of shortest routes, selecting the node into the first plurality of nodes.

15. The device of claim 10, wherein the dividing the first plurality of nodes into a plurality of collections comprises:
determining travel time from the origin to each of the first plurality of nodes; and
clustering the first plurality of nodes based on similarity of the travel time to obtain the plurality of collections.

16. The device of claim 15, wherein the determining travel time from the origin to each of the first plurality of nodes comprises:
determining the travel time based on historical and real-time information about the traffic from the origin to each of the first plurality of nodes.

17. The device of claim 10, wherein the determining a route from the origin to the destination by selecting nodes from the plurality of collections comprises:
selecting a first node in a first collection of the plurality of collections;
determining connectivity associated with nodes in a second collection of the plurality of collections;
selecting, from among the nodes in the second collection, a second node with the highest connectivity; and
determining a segment of the route from the first node to the second node.

18. The device of claim 17, wherein the determining connectivity associated with nodes in a second collection of the plurality of collections comprises:
determining connectivity associated with a third node in the second collection by weighting at least one of the following factors:
a first parameter indicating connectivity from the third node to other nodes in the second collection;
a second parameter indicating connectivity from the third node to nodes in a third collection of the plurality of collections;
the determined travel time from the first node to the third node; and
the determined travel time from the third node to the destination.

19. A computer program product being tangibly stored on a non-transient machine-readable medium and comprising machine-executable instructions, the instructions, when executed on a device, causing the device to:
determine a first plurality of nodes from an origin to a destination;
divide the first plurality of nodes into a plurality of collections based on travel time; and
determine a route from the origin to the destination by selecting nodes from the plurality of collections.

20. The computer program product of claim 19, wherein the instructions, when executed on the device, further cause the device to determine the first plurality of nodes by:
generating, based on a road topology, a second plurality of nodes with connectivity exceeding a first predefined threshold; and
selecting, from among the second plurality of nodes, the first plurality of nodes.
